(19) United States
(12) Patent Application Publication
(10) Pub. No.: US 2009/0005086 A1
(43) Pub. Date: Jan. 1, 2009

(54) Method for Sending a Mail Letter Starting From a Sms Message

(76) Inventor: Marco Murzilli, Avezzano (IT)

Correspondence Address: YOUNG & THOMPSON, 209 Madison Street, Suite 500, ALEXANDRIA, VA, 22314, US

(21) Appl. No.: 11/658,455

(22) PCT Filed: Jul. 18, 2005
(86) PCT No.: PCT/IT05/00410

§ 371 Date: Jan. 26, 2007

(30) Foreign Application Priority Data
Jul. 29, 2004 (IT) RM2004A000384

(51) Int. Cl. H04Q 7/20

(52) U.S. Cl. 455/466

(57) ABSTRACT

A method of sending a mail letter by a SMS message sent by any terminal enabled to such operation to an addressee having a telephone number, characterized in that the SMS message is sent to a Service Centre that transmits it to the telephone service provider of the sender who once identified the personal data corresponding to the telephone number included in the message transmits said personal data together with the text of the SMS message to an equipment designed to print the message, to put it into an envelope, and to hand it over to the postal service to be delivered to the addressee.

The present invention concerns communication and particularly relates to a method of sending a mail letter from an ordinary SMS message directly to the addressee of the message whose telephone number is known.

Presently several ways of communication in writing, i.e. by paper, are known.

A first way consists of writing a letter which will be sent by mail to the addressee.

A second way consists of sending a telegram through post office or by dictating the text through telephone line to the operators of a Telephone Company, with the drawback of considerable costs.

A third way consists of sending a facsimile with the drawback that both the sender and the addressee should have got a fax machine, with the result of considerable cost.

A fourth way for communicating or exchanging information in writing is offered by the electronic mail that has the drawback of imposing the access to Internet and the knowledge and the availability of data processing means.

A further way of communication is the mobile telephony the users of which are essentially the whole population in Italy today exchanging information of any kind by messages or SMS which are sent from a mobile phone to another. SMS have been getting more and more widespread in time among the people as the easiest way to communicate because of the low cost and the easiness in writing the messages. It should be appreciated that the number of SMS sent over the world passed from about 15 thousand millions to about 530 thousand millions in the years 2000 to 2003. A drawback of the communication by SMS is that the message stored in the memory of the mobile phone cannot be printed.

The present invention seeks to provide a method that allows those having a terminal apparatus enabled to SMS message to send a mail letter only by sending a SMS.

This is accomplished according to a preferred embodiment of the invention by putting the telephone number of the addressee of the message preceded by an alphanumeric string identifying the required service preferably at the head of the SMS-text, and then by sending such SMS to a Service Centre.

The Service Centre transmits the SMS-text to the relative telephone service provider who singles out the required service from the alphanumeric string and identifies the personal data (name, surname, and mail address) of the addressee by his/her telephone number, and transmits all such information to a suitable equipment which prints the message, puts it into an envelope and hands it over to the postal service for the home delivery.

A better understanding of the invention will result from the following detailed description with reference to the accompanying drawings that show a preferred embodiment thereof only by way of a not limiting example.

In the drawings:

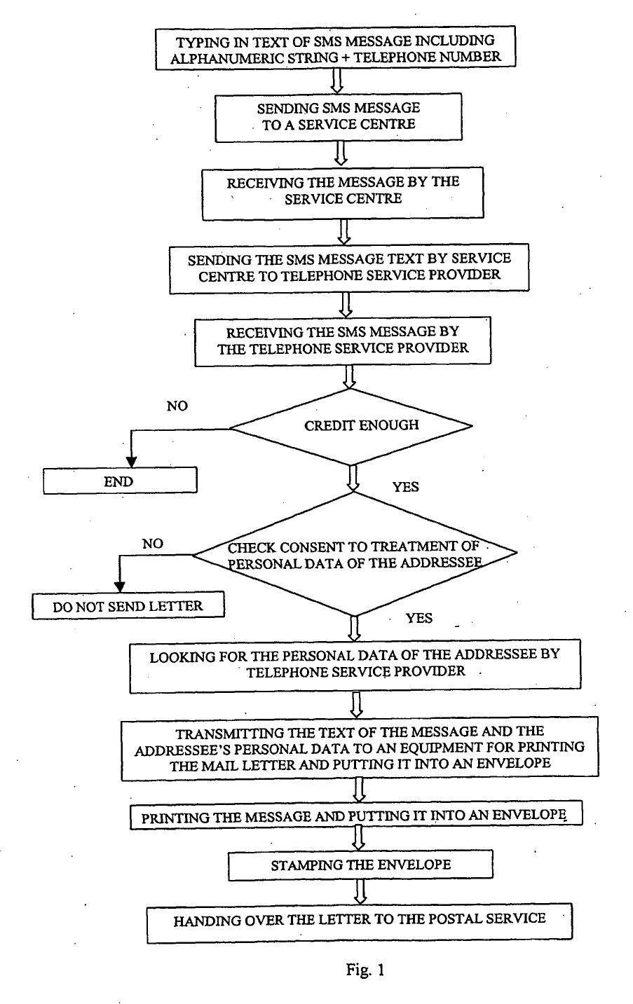

FIG. 1 shows a flowchart of the method of sending a mail letter by a SMS.

According to a peculiar feature of the invention the SMS message is sent to the Service Centre instead of directly to the telephone number of the addressee. Once received the message, the Service Centre transmits it to the relative telephone service provider who first identifies the personal data corresponding to the telephone number included in the message by a data processing centre, and then transmits the text of the SMS message and the personal data to a Centre designed to print the message and to put it into an envelope.

Thus, the telephone service provider produces printed records to check and to charge the relative cost.

In case the sender does not have credit enough for the operations required, the message is not sent.

There can be provided that the provider ascertains that the addressee gave or not the approval to the receipt of the message on the base of either a preventive consent or an express request via SMS to be confirmed.

The sender can also personalize the mail letters, for example by printing a coloured text and/or by sending a post card.

It is further provided to send enclosures taken from a suitable Internet site or other sources of the known type: in this case the equipment for printing and putting the message into an envelope is provided with a data processing unit able to detect that the message should be supplied with a personalization (imagine, text, etc.) selected by the sender.

To this end, the alphanumeric string included in the SMS message has at least a field relative to the postal service required and any further fields relative to the personalization in order to allow the sender to select the postal service and/or the personalization of the mail letter.

It is evident that the personalization of the letter requires a further cost with respect to that for the basic mail service.

With regard to the foregoing, the method of sending a mail letter to an addressee provided with telephone number by a SMS message sent from any terminal enabled to such operation includes essentially the following steps (FIG. 1):

1. typing in the text of the SMS message which has to begin with an alphanumeric string identifying the required service followed by the telephone number of the addressee;

2. sending a SMS message to a Service Centre;

3. receiving the message by the Service Centre;

4. sending the text of the SMS message by the Service Centre to the telephone service provider of the sender;

5. receiving the message by the telephone service provider;

6. charging the cost of the required operation to the telephone credit of the sender subject to check of the availability of enough credit;

7. possible check by the telephone service provider that the addressee gave his/her consent to the treatment of his/her personal data;

8. looking for the personal data corresponding to the addressee's telephone number by the telephone service provider;

9. transmitting the text of the message and the personal data from the telephone service provider to an equipment for printing the mail letter and putting it into an envelope;

10. printing the message on paper and putting it into an envelope by the above-mentioned equipment as well as printing the personal data of the addressee on the outer side of the envelope;

11. stamping the envelope;

12. handing over the letter to the postal service to be delivered.

In case of a possible check (step 7) if the addressee did not give his/her consent to the treatment of his/her personal data, the letter will not be sent.

To put the letter into an envelope as per step 10, the printed sheet is forwarded to an apparatus that:

a. folds the sheet so as to form a wrapping similar to a common envelope to be mailed including a closure flap;

b. applies a hot melt adhesive sidewise to the sheet upon folding and pressing the same and perforates it laterally to allow its pull-out opening;

c. carries the envelope on a conveyer belt to collect letters.

The postage of the envelope as per step 11 depends on the type of shipment by which the sender wants to deliver the letter to the addressee: ordinary mail, priority mail, registered mail, registered mail with acknowledgement of receipt, etc.

Preferably powered means are provided to collect and to store the envelopes in suitable boxes and/or mailbags ready to be mailed.

To print messages it would be suitable, even if not mandatory, to use an endless form for the following advantages:

a greater speed than the single sheet;

a clearly greater printing output because of the continuity of the paper support;

a greater output also with regard to the finishing systems;

a greater certainty of consistent progressive steps and then a logic flow of printed paper material;

saving in paper purchase;

saving in the operative cost in case of 2up print.

It is suitable that the printing equipment is located near postal facilities located in turn near stations and/or airports to reduce the transport of the letter to be delivered to a minimum.

Advantageously, according to the invention, the sender can also send a postal letter to an addressee only knowing his/her telephone number but not the postal address, thus respecting the privacy of the addressee.

A second advantage is that the cost of sending a SMS message and delivering its printed form is lower than a facsimile and a telegram.

A third advantage, as already mentioned, is that sending a mail letter is as easy as sending a SMS message.

A fourth advantage is the possibility for the user to use this service to mail quickly and easily.

A fifth advantage is that the single messages can consists of mailing and sponsorship by third companies so as to reduce the cost for the users or to increase the gain of the telephone service provider.

At last, a further advantage consists of giving a formal guise to the official communications such as invitations to meetings that need a printed paper to be considered valid.

The present invention has been described and illustrated according to a preferred embodiment thereof, however, it is self-evident that those skilled in the art can make technically equivalent modifications and/or replacements without departing from the scope of the present industrial invention.

1-13. (canceled)

14. A method of sending a mail letter by a SMS message sent by any terminal enabled to such operation to an addressee having a telephone number, characterized in that the SMS message is sent to a Service Centre that transmits it to the telephone service provider of the sender who once identified the personal data corresponding to the telephone number included in the message transmits said personal data together with the text of the SMS message to an equipment designed to print the message, to put it into an envelope, and to hand it over to the postal service to be delivered to the addressee; the personal data of the addressee being not communicated to the sender.

15. The method according to claim 14, characterized in that there are provided the following steps:
1. typing in the text of the SMS message which has also to include the telephone number of the addressee preceded by an alphanumeric string identifying the required service;
2. sending the SMS message to the Service Centre;
3. receiving the message by the Service Centre;
4. sending the text of the SMS message by the Service Centre to the telephone service provider of the sender;
5. receiving the message by the telephone service provider;
6. charging the cost of the required operation to the telephone credit of the sender subject to check of the availability of enough credit;
7. looking for the personal data corresponding to the addressee's telephone number by the telephone service provider;
8. transmitting the text of the message and the personal data from the telephone service provider to an equipment for printing the mail letter and putting it into an envelope;
9. printing the message on paper and putting it into an envelope by the above-mentioned equipment as well as printing the personal data of the addressee on the outer side of the envelope;
10. stamping the envelope;
11. handing over the letter to the postal service to be delivered.

16. The method according to the claim 15, characterized in that if the telephone credit of the sender is not enough upon checking its availability as per step 6, the message is not sent.

17. The method according to claim 15, characterized in that the telephone service provider is provided with a data processing unit to look for the personal data corresponding to the telephone number of the addressee of the SMS message as per step 7.

18. The method according to claim 15, characterized in that to put the letter into an envelope as per step 9, the printed sheet is forwarded to an apparatus that:
a. folds the sheet so as to form a wrapping similar to a common envelope to be mailed including a closure flap;
b. applies a hot melt adhesive sidewise to the sheet upon folding and pressing the same and perforates it laterally to allow its pull-out opening;
c. carries the envelope on a conveyer belt to collect letters.

19. The method according to claim 15, characterized in that the postage of the envelope as per step 10 depends on the type of shipment by which the sender wants to deliver the letter to the addressee: ordinary mail, priority mail, registered mail, registered mail with acknowledgement of receipt, etc.

20. The method according to claim 14, characterized in that the printing of a coloured text and/or a post card is provided to personalize the mail letters.

21. The method according to claim 14, characterized in that sending enclosures taken from a suitable Internet site or other sources of the known type is provided to personalize the mail letters.

22. The method according to claim 20, characterized in that the equipment for printing and putting the printed message into an envelope is provided with a data processing unit able to detect that the message has to be printed with personalization.

23. The method according to claim 19, characterized in that the alphanumeric string included in the SMS message has at least a field relative to the postal service required and any further fields relative to the personalization in order to allow the sender to select the postal service and/or the personalization of the mail letter.

24. The method according to claim 15, characterized in that the alphanumeric string and the telephone number of the addressee are positioned in this order at the beginning of the message.

25. The method according to claim 15, characterized in that step 7 is preceded by a further step in which the telephone service provider checks that the addressee gave his/her consent to the treatment of his/her personal data, otherwise the mail letter is not sent.

26. The method according to claim 21, characterized in that the equipment for printing and putting the printed message into an envelope is provided with a data processing unit able to detect that the message has to be printed with personalization.

27. The method according to claim 20, characterized in that the alphanumeric string included in the SMS message has at least a field relative to the postal service required and any further fields relative to the personalization in order to allow the sender to select the postal service and/or the personalization of the mail letter.

28. The method according to claim 16, characterized in that the alphanumeric string and the telephone number of the addressee are positioned in this order at the beginning of the message.
